(19) United States
(12) Patent Application Publication
(10) Pub. No.: US 2003/0227544 A1
(43) Pub. Date: Dec. 11, 2003

(54) Exterior inspection apparatus for workpieces and exterior inspection method

(76) Inventors: Takuya Hara, Hamamatsu-shi (JP); Toru Ishii, Hamamatsu-shi (JP); Takeshi Ito, Hamamatsu-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/453,587

(22) Filed: Jun. 4, 2003

(30) Foreign Application Priority Data
Jun. 6, 2002 (JP) P2002-165122

(51) Int. Cl. H04N 7/18

(52) U.S. Cl. 348/92

(57) ABSTRACT

A workpiece is transported by a feeder to a sloping block. As the workpieces pass along a sloping portion of the sloping block, their attitudes are corrected so that all workpieces have the same attitude. They are then discharged into a free space, and images are picked up by CCD cameras of the four side surfaces of each workpiece as it is falling through the space along a downward curve. Images of the top surface and bottom surface of each falling workpiece are also picked up by CCD cameras positioned away from the downward curve of the workpiece.

### BACKGROUND OF THE INVENTION

1. Field of the Invention

The present invention relates to an exterior inspection apparatus for workpieces and an exterior inspection method for performing exterior inspections of respective surfaces of workpieces by performing image pickup using an image pickup unit.

2. Description of the Related Art

Conventionally, an exterior inspection is performed on chips such as capacitors and inductors used in electronic equipment using an image processing unit that employs a CCD camera. An example of this type of exterior inspection apparatus that performs an exterior inspection is disclosed in Japanese Patent Application Laid-Open (JP-A) No. 07-88442. This exterior inspection apparatus performs an exterior inspection of a workpiece using the following procedure. Rectangular parallelepiped-shaped workpieces are sent from a part feeder to a top end portion of a tubular product chute and are passed through the interior of the product chute. The attitudes of these workpieces are then made uniform by a product cutting apparatus provided at the bottom end of the product chute, and each workpiece is dropped into a space. Four cameras are positioned facing the path of the falling workpiece at the surfaces thereof that are perpendicular to the path of the workpiece, and images of the four side surfaces of the workpiece are picked up by these cameras.

However, in the above described conventional exterior inspection apparatus, because the workpieces fall in a vertical direction, an exterior inspection can be made of the four surfaces parallel to the direction of fall; therefore a drawback exists in that it is not possible to perform an exterior inspection of the top surface and bottom surface, which are perpendicular to the direction of fall. Moreover, because control of the transporting and movement of the workpieces in order to perform an image pickup inspection is restricted by a pressure pin, control of the timing at which this is locked and released, as well as control of the speed at which the workpieces are supplied to the chute is complex.

### SUMMARY OF THE INVENTION

The present invention was conceived in order to solve the above problems, and it is an object thereof to provide an exterior inspection apparatus for workpieces and an exterior inspection method that enable an exterior inspection to be performed simply, not only on surfaces of the workpiece that are parallel to the fall direction of the workpiece, but of all surfaces of the workpiece.

A workpiece exterior inspection apparatus of the present invention has a transporting device that transports workpieces, a correction and discharge device that causes the workpieces transported from the transporting device to pass along a sloping path that slopes downwards, and corrects each workpiece such that each workpiece has a uniform attitude, and discharges each workpiece into a space, and an image pickup device formed by a plurality of image pickup units that each pick up an image of a surface of a workpiece that has been discharged from the correction and discharge device and is falling through a space along a downward curve.

In the exterior inspection apparatus for a workpiece of the present invention having the above-described structure, the correction and discharge device is provided with a sloping path that slopes downwards, and workpieces that arrive from the transporting device are made to pass along this sloping path. As they pass along the sloping path, the attitude of each workpiece is corrected so that each workpiece has a fixed attitude. Thereafter, the workpieces all having a uniform attitude are discharged obliquely downwards in a space, and are made to fall through the space along a downward curve. In this case, immediately after the workpiece has been discharged from the correction and discharge device, the downward curve is a direction conforming to the slope of the sloping path; however, it thereafter changes to a curve that gradually approaches a vertical direction.

Therefore, if image pickup positions are set on the curve portion on the fall path of the workpieces, it is possible to set image pickup units at positions where they respectively face each surface of a workpiece at those image pickup positions from front-on. As a result, a direct image pickup of any of the surfaces of the workpiece becomes possible. Moreover, because an image of each surface of a workpiece can be picked up simultaneously as it falls through the space, an increase in the speed of the inspection can be achieved. In such cases, by feeding workpieces continuously from the transporting device, an even more efficient inspection can be performed.

A workpiece exterior inspection apparatus has a transporting device that transports workpieces, a correction and discharge device that corrects the workpieces transported from the transporting device such that each workpiece has a uniform orientation, and discharges each workpiece into a space, and an image pickup device formed by image pickup units that is placed at positions where they do not obstruct a fall path of the workpieces discharged from the correction and discharge device, and that pick up an image of at least one of a top surface and bottom surface of the workpieces falling through a space along the fall path.

In the exterior inspection apparatus for a workpiece according to the present invention having the above-described structure, if, for example, the fall path of a workpiece discharged into the space is a curved path along a downward curve, then by placing image pickup units at positions such that the fall path in the front-on direction of the bottom surface and top surface (i.e., surfaces perpendicular to the line of the curved path) of a workpiece at the image pickup position is not obstructed, and it is possible to pick up images of the top surface and bottom surface of the workpiece.

In this case, because the fall path of a falling workpiece gradually changes from a obliquely downward direction to a vertical direction, it is possible to pick up an image directly of the top surface of the workpiece from front-on using an image pickup device placed above, and to pick up an image directly of the bottom surface of the workpiece from front-on using an image pickup device placed underneath. It is also possible to add reflective mirrors to an image pickup device and to pick up images from front-on of the top surface and bottom surface of the workpiece reflected by the reflective mirrors using the image pickup device. Furthermore, if the fall path of a workpiece discharged into the space is a straight path in a vertical direction, it is possible to add reflective mirrors to the image pickup device that are placed at positions where the fall path is not obstructed, and to pick up images of the top surface and bottom surface of the workpiece reflected by the reflective mirrors using the image pickup device. In this case, it is also possible to place the image pickup device at a position where the fall path is not obstructed, and to pick up an image directly of the top surface and bottom surface of the workpiece.

A workpiece exterior inspection apparatus has a transporting device that transports workpieces formed as rectangular parallelepipeds, a correction and discharge device that causes the workpieces transported from the transporting device to pass along a sloping path that slopes downwards, and corrects each workpiece such that each workpiece has a uniform orientation, and discharges each workpiece into a space, a side surface image pickup device formed by four image pickup units that respectively pick up images of four surfaces of each workpiece that are parallel to the downward curve when the workpiece is discharged from the correction and discharge device and is falling through a space along a downward curve, and a top and bottom surface image pickup device formed by one or two image pickup units that are placed at positions where they do not obstruct the downward curve of the workpieces discharged from the correction and discharge device and falling through a space along the downward curve, and that pick up an image of at least one of a top surface and bottom surface of the workpieces when they are falling through a space along the downward curve.

In the exterior inspection apparatus for a workpiece according to the present invention having the above-described structure, the correction and discharge device uses a sloping path to correct the orientation of workpieces arriving from the transporting device such that each workpiece has a uniform orientation, and discharges the workpieces obliquely downwards in the space so that they fall along a downward curve. As a result, it is possible to pick up from front-on images of the four side surfaces of the workpiece that are parallel to the downward curve as the workpiece falls through the space by positioning four image pickup units peripherally to the image pickup positions. Moreover, it becomes possible to pick up an image of the top surface and bottom surface of a workpiece by placing image pickup units in the directions of the front on of the top surface and bottom surface of the workpiece when it is at the image pickup position. At this time, if a structure is employed in which reflective mirrors are provided and an image is picked up of the top surface and bottom surface of a workpiece via these reflective mirrors, it becomes possible to select positions to place the image pickup units that pick up images of the top and bottom surfaces of the workpiece from a wide range of positions, and thereby increase the degree of freedom when designing the apparatus.

A workpiece exterior inspection apparatus has a slope having an upper end and an lower end, a correction device that is provided at the slope and that controls the orientation of the workpiece so as to have a uniform orientation, a workpiece supplier that supplies the workpiece to the upper end of the slope, and at least one image pickup unit that picks up an image of a surface of the workpiece that has been discharged from the lower end of the slope.

In the exterior inspection apparatus for a workpiece according to the present invention having the above-described structure, the slope provides the correction device so as to correct the orientation of workpieces arriving from the workpiece supplier such that each workpiece has a uniform attitude, and discharges the workpieces obliquely downwards in the space so that they fall along a downward curve.

In this case, because a transporting device that is set as driving vibration generating apparatus is not provided, it is possible to simplify constitution of the exterior inspection apparatus.

A workpiece exterior inspection method has a transporting step in which workpieces are transported, a correction and discharge step in which the arriving workpieces are corrected such that each workpiece has a uniform orientation, and in which the workpieces are discharged obliquely downwards in a space so as to fall along a downward curve, and an image pickup step in which an image is picked up of each surface of a workpiece that has been discharged into a space and is falling along a downward curve.

In the exterior inspection method for a workpiece according to the present invention having the above-described structure, because a workpiece is made to fall along a downward curve and an image is picked up of each surface of the workpiece as it falls through a space, it becomes possible to pick up images of all surfaces of the workpiece and, at the same time, because it is possible to pick up images of all surfaces of the workpiece, highly efficient inspection becomes possible.

A workpiece exterior inspection method has a transporting step in which workpieces are transported, a correction and discharge step in which the arriving workpieces are corrected such that each workpiece has a uniform orientation, and each workpiece is discharged into a space, and an image pickup step in which an image of at least one of a top surface and bottom surface of each workpiece discharged into the space and falling is picked up from a position that does not obstruct the fall path of the workpiece.

In the exterior inspection method for a workpiece according to the present invention having the above-described structure, when a workpiece falls along a downward curve, the front-on directions of the top surface and bottom surface of the workpiece at the image pickup position lead to positions that are removed from the fall path. Therefore, it is possible to place image pickup devices at positions facing the top surface and bottom surface of the workpiece and to pick up images of the top surface and bottom surface of the workpiece. In this case, it is also possible to pick up the images via reflective mirrors. Furthermore, when a workpiece is falling in a vertical direction, it is possible to place reflective mirrors at positions where they do not obstruct the fall path and to pick up images using image pickup units of the top surface and bottom surface of the workpiece via these reflective mirrors, or to place the image pickup units at positions where they do not obstruct the fall path and then perform image pick up directly.

A workpiece exterior inspection method has a transporting step in which workpieces formed as rectangular parallelepipeds are transported, a correction and discharge step in which the arriving workpieces are corrected such that each workpiece has a uniform orientation, and in which the workpieces are discharged obliquely downwards in a space so as to fall along a downward curve, a side surface image pickup step in which an image is picked up of each of four surfaces of each workpiece that are parallel to the downward curve when the workpiece has been discharged into the space and is falling, and an image pickup step in which an image of at least one of a top surface and bottom surface of each workpiece discharged into the space and falling is picked up from a position that does not obstruct the fall path of the workpiece.

In the exterior inspection method for a workpiece according to the present invention having the above-described structure, because it is possible to inspect six surfaces of a rectangular parallelepiped-shaped workpiece simultaneously, a highly efficient inspection can be performed. In addition, because all surfaces can be inspected, the accuracy of the inspection is improved.

### BRIEF DESCRIPTION OF THE DRAWINGS

FIG. 1 is a front elevational view showing an exterior inspection apparatus according to an embodiment of the present invention.

FIG. 2 is a plan view of a feeder, hopper, and supply chute provided in the exterior inspection apparatus shown in FIG. 1.

FIG. 3 is an enlarged view of the portions shown in the area a in FIG. 1.

FIG. 4 is a plan view of an inspection unit.

FIG. 5 is a perspective view showing a state when a workpiece falls from a sloping path.

FIG. 6 is an explanatory view showing a fall path of a workpiece and positions of reflective mirrors.

### DESCRIPTION OF THE PREFERRED EMBODIMENTS

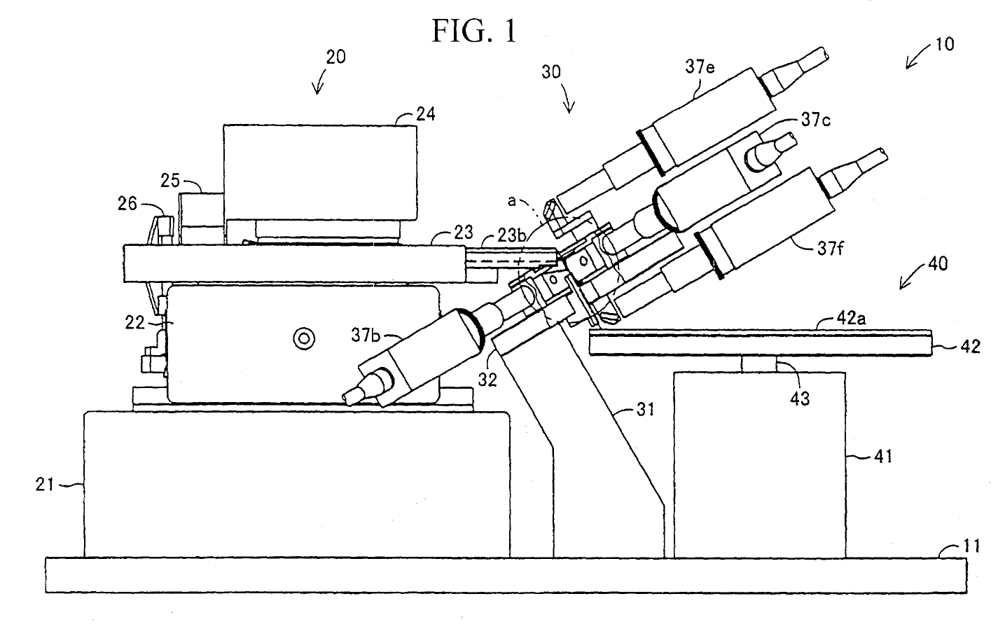

Embodiments of the present invention will now be described with reference to the drawings. FIG. 1 shows an exterior inspection apparatus 10 according to the present invention. A bottom portion of this exterior inspection apparatus 10 is formed by a square plate-shaped base portion 11 having rails (not shown) formed on a top surface thereof. On the top surface of the base portion 11 are provided a workpiece supply unit 20, an inspection unit 30, and a sorting unit 40, each of whose positions along the rails are able to be adjusted (i.e., to the left or right in FIG. 1).

The bottom portion of the workpiece supply unit 20 is formed by a moving base 21 that is engaged with the rails of the base portion 11. Various adjusting screws and fixing screws (not shown) are provided on the moving base 21. The position of the moving base 21 is fixed by moving the moving base 21 along the rails so that it is positioned at an optional position on the base portion 11, and then tightening the fixing screws. In addition, by adjusting the adjusting screws, the position of the moving base 21 in a vertical direction and forward-rearward direction (the near most portion in the drawings is the front) relative to the base portion 11 can be adjusted.

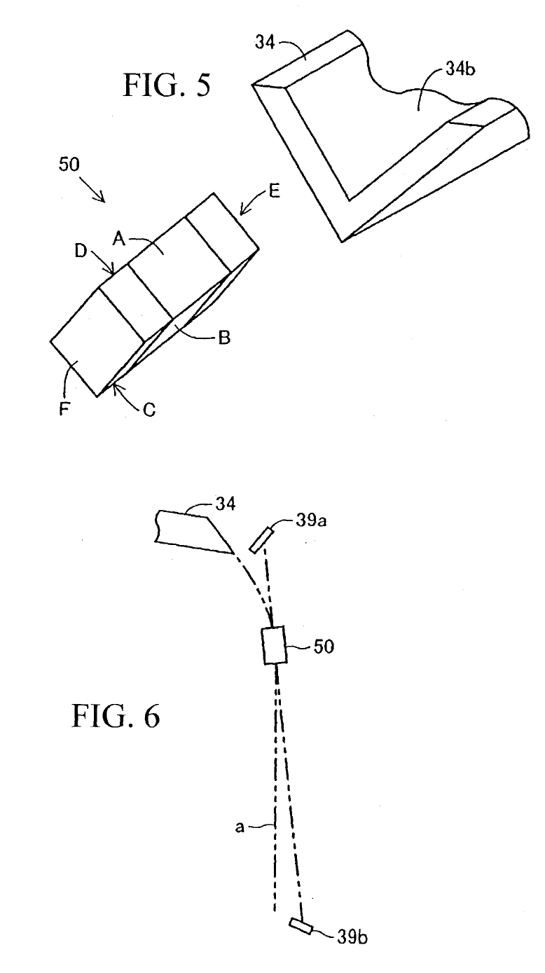

A vibration generating device 22 inside that is housed a vibration generating mechanism having a motor or the like is mounted on the top surface of the moving base 21. In addition, a feeder 23 for feeding workpieces 50 (see FIG. 5) to the inspection unit 30 is mounted on the top surface of the vibration generating device 22. Above the feeder 23 there is provided a hopper 24 for temporarily holding the workpieces 50. A supply chute 25 for supplying workpieces 50 that are inside the hopper 24 to the feeder 23 is provided at a bottom portion of one end of the hopper 24.

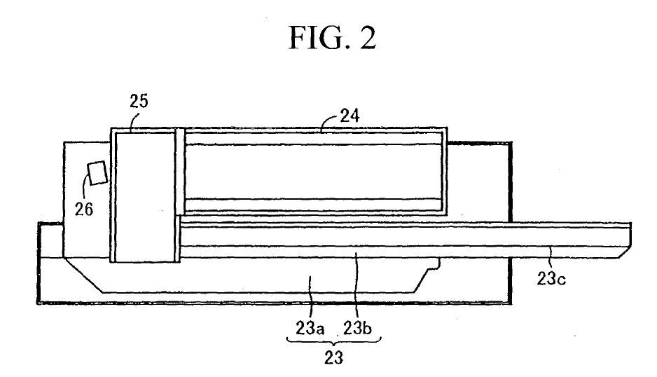

A discharge aperture for discharging workpieces 50 to the supply chute 25 is provided at the portion of the hopper 24 that connects with the supply chute 25. Moreover, the hopper 24 is provided at a higher position on the rear portion of the top surface of the moving base 21 than the position thereon at which the feeder 23 is mounted via a support portion. A plan view of the structure of the feeder 23, hopper 24, and supply chute 25 is shown in FIG. 2.

That is, the feeder 23 is placed horizontally, and is formed by a wide planar workpiece receiving portion 23a formed at the front portion (i.e., the lower portion in FIG. 2) of the feeder 23 and a narrow groove-shaped workpiece transporting portion 23b formed at the rear portion of the feeder 23. A cross-sectional configuration of the workpiece transporting portion 23b at a point where a substantially central portion of the workpiece transporting portion 23b in the longitudinal direction thereof forms a trough portion 23c is formed in a V shape groove configuration. The two side surfaces forming the V shape of this groove are each formed at an angle of 45 degrees from a horizontal plane, so that the angle between the two side surfaces is set at 90 degrees. The workpiece receiving portion 23a and the workpiece transporting portion 23b are formed as separate bodies, and the distal end portion of the workpiece transporting portion 23b extends out towards the inspection unit 30 beyond the distal end portion of the workpiece receiving portion 23a.

The workpiece receiving portion 23a is vibrated by the driving of the vibration generating device 22 so as to move workpieces 50 supplied via the supply chute 25 from the hopper 24 to the rear end portion of the workpiece transporting portion 23b. The workpiece transporting portion 23b is vibrated by the driving of the vibration generating device 22 so as to align workpieces 50 sent from the workpiece receiving section 23a in a row in the trough portion 23c of the groove, and move them to the distal end of the workpiece transporting portion 23b. A sensor 26 is provided at a side portion of the supply chute 25 and detects workpieces 50 inside the feeder 23. If the sensor 26 detects that the number of workpieces 50 inside the feeder 23 has decreased, the hopper 24 is vibrated by a vibration device (not shown) so that a workpiece 50 is released to the supply chute 25.

Furthermore, as a transporting device, a belt conveyor, a rubber conveyor, an air conveyor, etc., can be used as well as the feeder 23.

Moreover, the transporting device is not limited to the constitution of a driving vibration generating apparatus, and instead, a constitution may be employed of a slope. That is, the slope having an upper end and a lower end, a correction device that is provided at the slope and that controls a workpiece having a uniform attitude, and a workpiece supplier that supplies the workpieces to the upper end of the slope, may be provided at a workpiece supply unit.

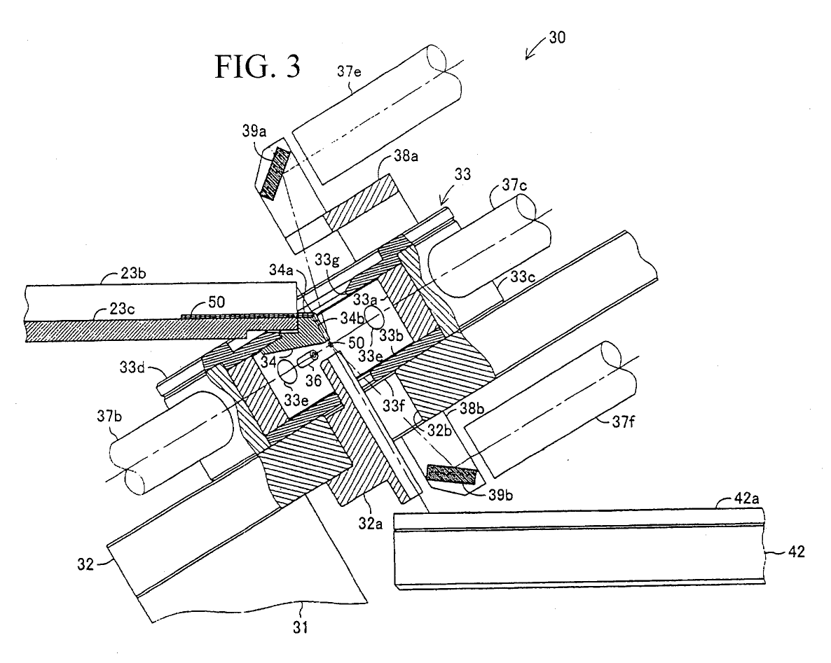

The inspection unit 30 is formed by placing a main body portion that performs the inspection on a top surface of a lower moving base 31. The moving base 31 engages with rails on the base portion 11 and can be fixed at an optional position on the rails on the base portion 11. The upper portion of the moving base 31 is bent towards the distal end portion of the feeder 23 of the workpiece supply unit 20, and a planar base plate 32 is mounted to the top end thereof such that the top surface of the base plate 32 is inclined towards the feeder 23. As is shown in FIG. 3 (an enlargement of the area indicated by the symbol a in FIG. 1), in the center of the base plate 32 is mounted a discharge chute 32a that discharges workpieces 50 that have completed image pickup from the inspection unit 30, and the base plate 32b is also provided with an transmission aperture 32b used for picking up an image of the bottom surface of the workpieces 50.

The base plate 32 is fixed when one end side portion of the bottom surface thereof is correctly positioned on the top end surface of the moving base 31. The discharge chute 32a is mounted at the side of the moving base 31 on a peripheral portion of the aperture 32b, and the portions thereof that form surface portions are formed with a semicircular groove shaped cross section. The portion of the aperture 32b facing the groove surface of the discharge chute 32a is formed as a space.

On the top surface of the base plate 32 is mounted a connecting portion 33 used for image pickup that forms a passage connecting the groove of the workpiece transporting portion 23b in the feeder 23 with the groove of the discharge chute 32a, and that is provided with respective members and the like for picking up images of the respective surfaces of a workpiece 50. The image pickup connecting portion 33 is formed by a short, cylindrical space forming portion 33a, a bottom surface portion 33b mounted on the bottom surface of the space forming portion 33a, an outer coat portion 33c provided at the outer periphery of the space forming portion 33a and the bottom surface portion 33b, and a top surface portion 33d mounted on a top surface of the space forming portion 33a and the outer coat portion 33c.

At a side portion formed by the space forming portion 33a and the outer coat portion 33c, four transmission apertures 33e (only two of which are shown in FIG. 3) that penetrate from the inner peripheral surface of the space forming portion 33a to the outer peripheral surface of the outer coat portion 33c are provided equidistantly around the circumference. In addition, in the center of the bottom surface portion 33b is provided an aperture 33f whose diameter is smaller than the diameter of the aperture 32b of the base plate 32 and is also smaller than the aperture of the space forming portion 33a. A top end portion of the discharge chute 32a passes through the aperture 33f and extends as far as the vicinity of the center of the space forming portion 33a. In addition, an aperture 33g having a diameter that is smaller than the diameter of the opening of the space forming portion 33a and larger than the diameter of the aperture 33f of the bottom surface portion 33b is provided in the center of the top surface portion 33d, and a sloping block 34 is mounted on edge portions of the aperture 33g.

A top surface of the sloping block 34 is formed by a horizontal portion 34a and a sloping portion 34b that slopes downwards from the distal end of horizontal portion 34a. The sloping block 34 is mounted on the top surface portion 33d of the image pickup connecting portion 33 with the rear end portion of the horizontal portion 34a positioned at the distal end of the workpiece transporting portion 23b of the feeder 23. V shaped grooves having an identical cross-sectional configuration to the grooves formed in the workpiece transporting section 23b are formed in the horizontal portion 34a and the sloping portion 34b of the sloping block 34, and these V shaped grooves are formed so as to be aligned with the grooves of the workpiece transporting portion 23b. The bottom end portion of the grooves in the sloping portion 34b of the sloping block 34 extends to the vicinity of substantially the center of the space in the image pickup connecting portion 33 above the discharge chute 32a.

The grooves in the sloping portion 34b of the sloping block 34 and the discharge chute 32a are placed parallel to each other, and the grooves in the sloping portion 34b of the sloping block 34 and the discharge chute 32a are placed so as to be perpendicular to the top surface of the image pickup connecting portion 33 and the base plate 32. Note that the sloping block 34 is mounted such that the rear end portion thereof is positioned extremely close to the distal end portion of the workpiece transporting portion 23b but does not actually touch it, so that no vibration is transmitted thereto from the workpiece transporting portion 23b. Accordingly, the sloping block 34 stop the vibrating of workpieces 50 that arrive vibrating and are arranged in a line from the feeder 23, and forwards them to the distal end of the horizontal portion 34a. They then slide down the sloping portion 34b. The workpieces 50 are then discharged into a space from the bottom end of the sloping portion 34b, and are dropped onto the groove portion of the discharge chute 32a. Furthermore, a sloping tube can be used instead of the sloping block 34.

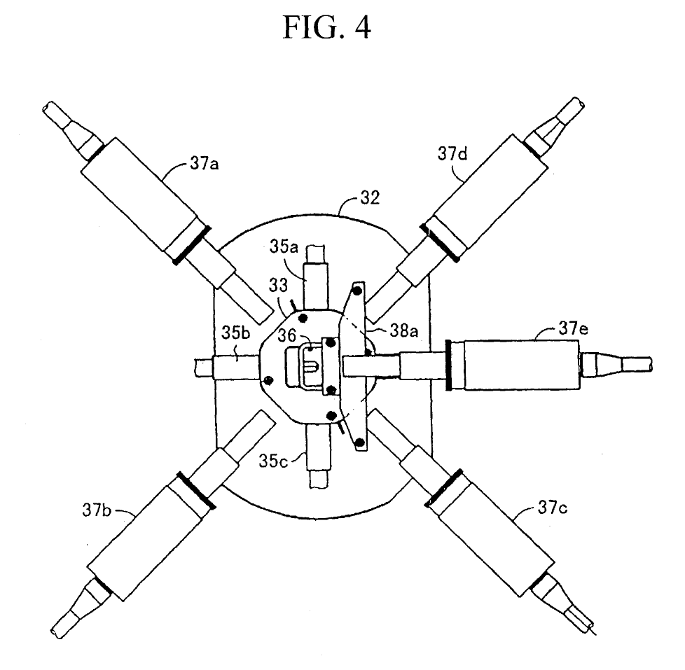

As is shown in FIG. 4, four illumination devices 35a, 35b, 35c, and the like (only three illumination devices are shown in FIG. 4) are provided at equal intervals around the circumference of the image pickup connecting portion 33. These four illumination devices are able to illuminate side surfaces of a workpiece 50 as it falls from the sloping block 34. A transmission sensor 36 functioning as an image pickup trigger is mounted on an inner circumferential surface of the space forming portion 33a of the image pickup connecting portion 33. The transmission sensor is able to detect a workpiece 50 as it falls from the sloping block 34. The illumination devices 35a and the like perform their illumination when the transmission sensor 36 detects a workpiece 50.

Further, four CCD cameras 37a, 37b, 37c, and 37d are provided at the circumference of the image pickup connecting portion 33. The four CCD cameras are able to pick up images of side surfaces of a workpiece 50 as it falls from the sloping block 34 via four transmission apertures 33e. Two CCD cameras 37e and 37f are also provided above and below the image pickup connecting portion 33 and are able to pick up images of the top surface and bottom surface of the workpiece 50.

A reflective mirror 39a is provided via a bracket 38a on a top surface of the image pickup connecting portion 33. Using the reflection from this reflective mirror 39a a CCD camera 37e is able to pick up an image of the top surface of a workpiece 50. In addition, a reflective mirror 39b is provided via a bracket 38b on a bottom surface of the base plate 32, and using the reflection from this reflective mirror 39b a CCD camera 37f is able to pick up an image of the top surface of a workpiece 50. At this time, images photographed by the CCD cameras 37a and the like are clear and distinct due to the illumination of the illumination devices 35a and the like.

The sorting unit 40 is formed by a moving base 41 forming the lower portion thereof and a rotating table 42 forming the upper portion thereof. The moving base 41 is engaged with the rails of the base portion 11 such that the position of the moving base 41 can be adjusted. Inside the moving base 41 is housed a drive mechanism provided with an electric motor or the like for causing the rotating table 42 to rotate. The rotating table 42 is connected to the drive mechanism of the moving base 41 via a rotation shaft 43. The top surface of the rotating table 42 is formed by a circular plate-shaped rubber plate 42a. An outer peripheral portion of the rubber plate 42a faces a bottom end portion of the discharge chute 32a, and the rotating table 42 is mounted horizontally on the moving base 41.

Two air jet devices (not shown) are mounted at a predetermined spacing on an outer peripheral side portion above the rotating table 42. A non-defective article receiving box and a defective article receiving box (not shown) that each receive workpieces 50 are placed below an end portion of the rotating table 42 facing the air jet devices. Sensors for detecting the respective workpieces 50 are mounted in the vicinity of the air jet devices.

The sorting unit 40 receives workpieces 50 that have been inspected and have fallen from the discharge chute 32a using the rotation of the rotating table 42. The sorting unit 40 then lines up the workpieces 50 at a predetermined interval on an outer peripheral portion of the top surface of the rotating table 42, and then transports them in the direction of the two article receiving boxes. When a non-defective workpiece 50 passes beside the non-defective article receiving box, the sensor detects the workpiece 50 and the air jet device is operated as a result of this detection. This workpiece 50 is then blown into the non-defective article receiving box. When a defective workpiece 50 passes beside the defective article receiving box, the sensor detects the workpiece 50, and the air jet device is operated as a result of this detection. This workpiece 50 is then blown into the defective article receiving box. Using this process, the workpieces 50 can be sorted into non-defective articles and defective articles.

In addition to the respective apparatuses and the like mentioned above, the exterior inspection apparatus 10 is provided with an image processing device that includes the CCD camera 37a and the like and an electrical control unit provided with a CPU, ROM, and RAM. The image processing device performs image processing on images picked up by the CCD camera 37a and the like, and makes a judgment as to whether a workpiece 50 is a non-defective article or a defective article. A screen for providing an enlarged display of the six surfaces of each workpiece 50 is also provided in the image processing device, and by viewing this screen an operator is also able to make a visual determination.

Next, a description will be given of an exterior inspection performed using an exterior inspection apparatus 10 having the structure described above with a capacitor chip as the workpiece 50 being inspected shown in FIG. 5. The workpiece 50 formed by the capacitor chip is made from ceramic and has electrodes formed at both end portions thereof. The length of the workpiece 50 is 1 mm, and the vertical and horizontal widths are each set at 0.5 mm.

When making the inspection, firstly, the workpieces 50 to be inspected are collected in the hopper 24 of the workpiece supply unit 20, and the power supply switch of the exterior inspection apparatus 10 is turned on, resulting in each device provided in the exterior inspection apparatus 10 starting operation. In the workpiece supply unit 20, a predetermined number of workpieces 50 are supplied from the discharge aperture of the hopper 24 to the feeder 23 via the supply chute 25. In this case, when the sensor 26 detects that the number of workpieces 50 inside the feeder 23 has decreased, the hopper 24 is vibrated and a workpiece 50 is supplied from the discharge aperture to the feeder 23. As a result, a predetermined number of workpieces 50 are constantly kept in the feeder 23.

The workpieces 50 supplied to the feeder 23 are moved by the driving of the vibration generating device 22 from the workpiece receiving portion 23a and are collected at the rear end portion of the workpiece transporting portion 23b. The angle portions in the longitudinal direction of the workpieces 50 that have been collected at the rear end portion of the workpiece transporting portion 23b are matched with the trough portion 23c of the groove in the workpiece transporting portion 23b, and when the workpieces 50 are placed adjacently end to end, they form a single row in the groove of the workpiece transporting portion 23b. Subsequently, due to the driving of the vibration generating device 22, the workpieces 50 are advanced to the distal end of the workpiece transporting portion 23b along the trough portion 23c while retaining their alignment in the single row, and are transported to the groove in the horizontal portion 34a of the sloping block 34.

The workpieces 50 that are transported to the horizontal portion 34a of the sloping block 34 are no longer affected by the vibration and, in a state in which the end surface of each workpiece 50 is in contact with the end surface of the preceding workpiece 50, each one is pushed by the following workpiece 50 so as to move to the distal end of the horizontal portion 34a. When a workpiece 50 reaches the distal end of the horizontal portion 34a, its front portion is inclined downwards and it advances into the groove of the sloping portion 34b. It then descends along the groove of the sloping portion 34b. Two of the four side surfaces of the workpiece 50 slide against the two side surfaces forming the groove of the sloping portion 34b, thereby placing the workpiece 50 in the correct orientation before the workpiece 50 reaches the bottom end of the sloping portion 34b. Next, as is shown in FIG. 5, when all the workpieces 50 have a uniform orientation in which the two end surfaces thereof face up and down on a slight inclination, the workpieces 50 are discharged obliquely downward from the bottom end of the sloping portion 34b into a space.

The position where the sloping block 34 is located relative to the image pickup connecting portion 33 is set such that the workpieces 50 pass through the center portion of the space in the image pickup connecting portion 33 when they fall. When a workpiece 50 passes through the center portion of the image pickup connecting portion 33, the transmission sensor 36 detects the workpiece 50. As a result, the illumination device 35a and the like are turned on and illuminate the side surfaces of the workpiece 50. In addition, the CCD cameras 37a to 37f pick up images of the respective surfaces A, B, C, and D of the relevant workpiece 50.

That is, the CCD cameras 37a to 37d each pick up an image from front-on respectively of the surfaces A, B, C, and D of the workpiece 50. The CCD camera 37e picks up an image of the top surface E of the workpiece 50 from a slightly oblique direction via the reflective mirror 39a, while the CCD camera 37f picks up an image of the bottom surface F of the workpiece 50 from a slightly oblique direction via the reflective mirror 39b. A determination as to the quality of the images thus picked up of the six surfaces is then made by an image processing device. This determination is made by comparing the external dimensions, contamination, blemishes, the adherence of contaminants, the existence or otherwise of markers provided in advance, and the like with predetermined standards. In this case, because enlarged images of the six surfaces picked up are displayed on the screen of the image processing device, an operator is able to ascertain from the screen as well what type of defect is present in which portion of the workpiece 50.

A workpiece 50 whose quality has been determined falls into the groove of the discharge chute 32a and descends along the groove in the discharge chute 32a. It then falls onto the top surface of the rotating table 42 of the sorting unit 40. The workpiece 50 is then carried by the rotating table 42 and if the workpiece 50 is not defective it is blown into the non-defective article receiving box by the operation of the corresponding air jet device. If the workpiece 50 is defective, it is blown into the defective article receiving box by the operation of the corresponding air jet device. As a result, the workpieces 50 are sorted into non-defective articles and defective articles and are collected in the respective receiving box.

In this way, according to this exterior inspection apparatus 10, a groove having the same angle as the angle portion of the workpieces 50 is provided in the sloping portion 34b of the sloping block 34, and the workpiece 50 is made to descend while running along the groove of the sloping portion 34b. Accordingly, workpieces 50 that are discharged from the sloping block 34 are all corrected so as to have a uniform attitude, and all fall along a downward curve in an oblique direction through a space. Moreover, because the CCD cameras 37a to 37f are placed so as to be able to pick up images of each of the six surfaces of a workpiece 50 as it falls through the space, it is possible to make a simultaneous inspection of all of the surfaces of the workpiece 50.

Further, because the device for transporting workpieces 50 to the sloping portion 34b of the sloping block 34 is formed by the feeder 23 that has an identical groove to the groove in the sloping portion 34b, and the horizontal portion 34a of the sloping block 34, because the workpieces 50 are moved towards the horizontal portion 34a simply by causing the feeder 23 to vibrate, the structure of the transporting device can be made extremely simple. Moreover, by controlling the number of vibrations, the feeder 23 can control the speed at which the workpieces 50 are supplied. As a result, the interval between falling workpieces 50 can be controlled. In addition, because the workpieces 50 that arrive at the horizontal portion 34a are no longer being vibrated and fall one at a time at a fixed interval onto the sloping portion 34b at a constant attitude, even if the length of the sloping portion 34b is set short, the workpieces 50 discharged from the bottom end of the sloping portion 34b have a stable attitude with no irregularities. Consequently, an accurate inspection can be made.

As is shown in FIG. 6, the fall path of the workpieces 50 immediately after they have been discharged from the bottom end of the sloping portion 34b is at the same angle as slope angle of the sloping portion 34b; however, the fall path gradually changes to a vertical direction. Therefore, as in the present embodiment, by placing the image pickup positions in the vicinity of the bottom end of the sloping portion 34b, even if the positions where the reflective mirrors 39a and 39b are located are away from the fall path a of the workpieces 50, it is possible to pick up images of the top surface and bottom surface of a workpiece 50 from positions close to the direct front on positions of the top and bottom surfaces of the workpiece 50. Consequently, accuracy of inspection is improved.

Moreover, in the above-described embodiment, a structure is employed in which images of the top and bottom surfaces of a workpiece 50 are picked up by the CCD cameras 37e and 37f via the reflective mirrors 39a and 39b; however, it is also possible to pick up images by CCD cameras directly, without providing the reflective mirrors 39a and 39b. In this case, it is preferable that the position where the discharge chute 32a is installed be lowered even further from the bottom end of the sloping block 34 so as to lengthen the distance the workpiece 50 falls through the space. By doing this, because the distance traveled through the air by the workpiece 50 in a forward direction is reduced, the space needed to install the CDD cameras can be satisfactorily maintained.

Furthermore, it is also possible to reduce the slope angle (i.e., make it closer to horizontal) of the sloping portion 34b of the sloping block 34, so as to make the top surface of a falling workpiece 50 visible from the rear and make the bottom surface thereof visible from the front. By doing this as well, the placement of the CCD cameras used to pick up images of the top surface and bottom surface is simplified and image pickup from positions directly front-on relative to the top and bottom surfaces is possible. In addition, because the fall speed is decreased, the precision of the setting of the image pickup positions is improved, enabling a more accurate inspection to be made. Moreover, according to the present invention, the same excellent effects are obtained when the attitude of a workpiece 50 as it falls gradually changes from a sloping state to a vertical direction and when the sloping state of the fall path is maintained as it is.

What is claimed is:

1. A workpiece exterior inspection apparatus, comprising:
a transporting device that transports workpieces;
a correction and discharge device that causes the workpieces transported from the transporting device to pass along a sloping path that slopes downwards, and corrects the orientation of each workpiece such that each workpiece has a uniform orientation, and discharges each workpiece into a space; and
an image pickup device formed by a plurality of image pickup units that each pick up an image of a surface of a workpiece that has been discharged from the correction and discharge device and is falling through a space along a downward curve.

2. A workpiece exterior inspection apparatus, comprising:
a transporting device that transports workpieces;
a correction and discharge device that corrects the orientation of the workpieces transported from the transporting device such that each workpiece has a uniform orientation, and discharges each workpiece into a space; and
an image pickup device formed by image pickup units that are placed at positions where they do not obstruct a fall path of the workpieces discharged from the correction and discharge device, and that pick up an image of at least one of a top surface and bottom surface of the workpieces falling through a space along the fall path.

3. A workpiece exterior inspection apparatus according to claim 1, comprising:
a side surface image pickup device formed by four image pickup units that respectively pick up images of four surfaces of each workpiece that are parallel to the downward curve when the workpiece is discharged from the correction and discharge device and is falling through a space along a downward curve; and
a top and bottom surface image pickup device formed by one or two image pickup units that are placed at positions where they do not obstruct the downward curve of the workpieces discharged from the correction and discharge device and falling through a space along the downward curve, and that pick up an image of at least one of a top surface and bottom surface of the workpieces when they are falling through a space along the downward curve.

4. A workpiece exterior inspection apparatus, comprising:
a slope having an upper end and an lower end;
a correction device that is provided at the slope, and that controls the orientation of workpiece so as to have a uniform orientation;
a workpiece supplier that supplies the workpiece to the upper end of the slope; and
at least one image pickup unit that picks up an image of a surface of the workpiece that has been discharged from the lower end of the slope.

5. A workpiece exterior inspection method, comprising:
a transporting step in which workpieces are transported;
a correction and discharge step in which the orientation of arriving workpieces are corrected such that each workpiece has a uniform orientation, and in which the workpieces are discharged obliquely downwards in a space so as to fall along a downward curve; and
an image pickup step in which an image is picked up of each surface of a workpiece that has been discharged into a space and is falling along a downward curve.

6. A workpiece exterior inspection method according to claim 5, wherein an image pickup step in which an image of at least one of a top surface and bottom surface of each workpiece discharged into the space and falling is picked up from a position that does not obstruct the fall path of the workpiece.

7. A workpiece exterior inspection method, comprising:
a transporting step in which workpieces formed as rectangular parallelepipeds are transported;
a correction and discharge step in which the orientation of arriving workpieces are corrected such that each workpiece has a uniform orientation, and in which the workpieces are discharged obliquely downwards in a space so as to fall along a downward curve;
a side surface image pickup step in which an image is picked up of each of four surfaces of each workpiece that are parallel to the downward curve when the workpiece has been discharged into the space and is falling; and
an image pickup step in which an image of at least one of a top surface and bottom surface of each workpiece discharged into the space and falling is picked up from a position that does not obstruct the fall path of the workpiece.
